(19) United States
(12) Patent Application Publication
(10) Pub. No.: US 2008/0077473 A1
(43) Pub. Date: Mar. 27, 2008

(54) METHOD AND APPARATUS FOR COLLECTING INFORMATION RELATING TO THE POSSIBLE CONSUMER PURCHASE OF ONE OR MORE PRODUCTS

(76) Inventors: Catherine E. Allin-Bradshaw, Mission Hills, KS (US); Betsy J. Stewart, Lake Quivira, KS (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/739,519

(22) Filed: Apr. 24, 2007

Related U.S. Application Data
(60) Provisional application No. 60/826,853, filed on Sep. 25, 2006.

(51) Int. Cl. G06F 19/00; G06F 17/18; G06T 1/00

(52) U.S. Cl. 705/10; 345/418

(57) ABSTRACT

A method for collecting information related to the sale of products includes simulating a shopping environment, displaying a plurality of products within the simulated shopping environment, and collecting information based on a selection of at least one of the plurality of products by a user.

### CROSS-REFERENCE TO RELATED APPLICATIONS

This application claims the priority of and is a Non-Provisional of U.S. Patent Application Ser. No. 60/826,853 filed Sep. 25, 2006, which is hereby incorporated by referenced in its entirety.

### BACKGROUND OF THE INVENTION

This invention relates generally to collecting information relating to the sale of one or more products in retail environments such as a grocery store, a convenience store, mass merchants and drug and department stores.

Understanding the impact of altering how products are displayed, where products are located, features of products, packaging of products, and/or pricing of products on the purchasing behavior of potential customers can be difficult. For example, it may be difficult to predict the impact of product changes to the decision making process of customers having a high product knowledge.

### BRIEF DESCRIPTION OF THE INVENTION

In one aspect, a method for collecting information related to the sale of products includes simulating a shopping environment, displaying a plurality of products within the simulated shopping environment, and collecting information based on a selection of at least one of the plurality of products by a user.

In another aspect, a simulated shopping environment includes at least one client system, a database, and a server electronically coupled to the at least one client system and the database. The server is configured to simulate a shopping environment on the client system, display a plurality of products within the simulated shopping environment, and collect information based on a selection of at least one of the plurality of products by a user.

In a further aspect, a computer program embodied on a computer-readable medium for collecting information related to the sale of products includes a code segment configured to simulate a shopping environment, display a plurality of products within the simulated shopping environment, and collect information based on a selection of at least one of the plurality of products by a user.

### BRIEF DESCRIPTION OF THE DRAWINGS

FIG. 1 is a block diagram of an exemplary embodiment of a simulated shopping environment system (SSES).

FIG. 2 is a flowchart illustrating an exemplary embodiment of a method for collecting information relating the sale of one or more products, for example using the SSES shown in FIG. 1.

FIG. 3 is an exemplary embodiment of a user interface displaying an exemplary storefront.

FIG. 4 is an exemplary embodiment of a user interface displaying an end view of an exemplary aisle of products.

FIG. 5 is an exemplary embodiment of a user interface displaying a front view of the aisle of products shown in FIG. 4.

FIG. 6 is an exemplary embodiment of a user interface displaying, for example, four selected exemplary products with product information including price, ounce weight, from the aisle shown in FIGS. 4 and 5.

FIG. 7 is an exemplary embodiment of a user interface displaying a product selected for purchase from the products shown in FIG. 6.

FIG. 8 is an exemplary embodiment of a user interface displaying a user's selected items in a shopping cart.

FIG. 9 is an exemplary embodiment of a user interface displaying a front view of another end cap of an exemplary aisle of products.

FIG. 10 is an exemplary embodiment of a user interface displaying an exemplary questionnaire for the user.

FIG. 11 is an exemplary embodiment of a user interface displaying another exemplary questionnaire for the user.

### DETAILED DESCRIPTION OF THE INVENTION

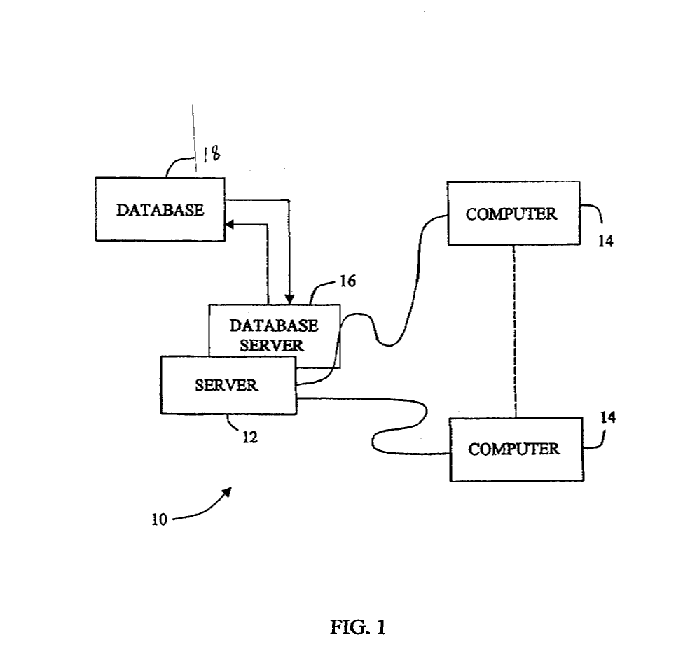

FIG. 1 is a block diagram of an exemplary embodiment of a simulated shopping environment system (SSES) 10. In the exemplary embodiment, SSES 10 includes a server system 12 and a plurality of client sub-systems, also referred to as client systems 14, connected to server system 12. In some embodiments, client systems 14 are computers that include a web browser, such that server system 12 is accessible to client systems 14 using the Internet. Client systems 14 may be interconnected to the Internet through any suitable interface, such as, but not limited to, dial-in-connections, cable modems, special high-speed ISDN lines, and/or a network, such as, but not limited to, a local area network (LAN) and/or a wide area network (WAN). In addition, platforms such as mobile phones and hand held PDSs can also be used. Client systems 14 may be any device capable of interconnecting to the Internet including, but not limited to, a web-based phone, personal digital assistant (PDA), and/or other web-based connectable equipment. In other embodiments, server system 12 is accessible to client systems 14 using a LAN, a WAN, and/or a direct connection, such as, but not limited to, any suitable cable that electrically connects client systems 14 to server system 12. Moreover, in other embodiments, a client system 14 is a single computer that includes server system 12.

Server system 12 includes a database server 16 that is electrically connected to a database 18. Database 18 includes product information stored therein for providing a simulated shopping environment using server system 12 and/or one or more client systems 14. Examples of product information include, but are not limited to, a price of one or more products, a general location of one or more products, a location of one or more products relative to one or more other products, a photograph and/or other image of one or more products, an advertisement for one or more products, a promotion for one or more products, an incentive for one or more products, a recommendation for one or more products, a demonstration of one or more products, a size of one or more products, a quantity of one or more products, a description of one or more products, a shape of one or more products, a quantity of one or more products, informational resources for one or more products, information relating to the nutrition and/or contents of one or more products, information relating to the packaging of one or more products, a displayed orientation of one or more products, and/or a configuration of a group of a plurality of the same and/or different products, for example a configuration of an aisle containing a plurality of products. In the exemplary embodiment, database 18 is a centralized database included within server system 12. In other embodiments, database 18 is stored remotely from server system 12 and may be non-centralized.

The architecture of SSES 10 and various components of SSES 10 described and/or illustrated herein are exemplary only. Other architectures and/or components are possible and may be utilized in connection with practicing the processes and/or methods described herein.

In some embodiments, SSES 10 may have one or more different access levels for restricting access to SSES 10. Authorization for access to SSES 10 may, in some embodiments, be assigned by a system administrator. Moreover, in some embodiments, administration and/or editing capabilities within SSES 10 may be restricted to ensure that only authorized individuals have access to modify or edit information and/or logic within SSES 10.

Generally, SSES 10 provides a simulated shopping environment for collecting information relating to the sale of one or more products. For example, in some embodiments, collecting information relating to the sale of one or more products includes collecting information relating to the shopping habits of potential customers and/or includes evaluating the effect of product changes on the purchasing behavior of potential customers. Product changes may include, but are not limited to including, changes to a price of one or more products, a general location of one or more products, a location of one or more products relative to one or more other products, a photograph and/or other image of one or more products, a size of one or more products, a shape of one or more products, a quantity of one or more products, information relating to the nutrition and/or contents of one or more products, information relating to the packaging of one or more products, a displayed orientation of one or more products, and/or a configuration of a group of a plurality of products (which may consist of a plurality of the same type of product or a plurality of different types of products that may include a plurality of one or more of the different product types), for example a configuration of an aisle containing a plurality of products. In some embodiments, SSES 10 includes HTML, JavaScript, Flash, Java, ASP/vbScript, and/or other suitable formats, whether existing or yet to be developed, for providing the simulated shopping environment and/or for collecting information relating to the sale of one or more products. In addition, 2D as well as 3D imaging technology is used in some embodiments.

Further, SSES 10 provides a system and method with which at least one of product manufacturers, retail stores, and restaurants can visually display products for customer purchase. In general, the system facilitates optimizing sales of products to customers. In one embodiment, the system optimizes sales by determining an optimal product placement in a store, eliminating a redundancy of products in the store, optimizing sales of a category of product types, and increasing an effectiveness of signage throughout the store. Further, in one embodiment, the system may be used to identify an optimal purchase price for products and maximize a product's packaging appeal to facilitate detracting customers from competitor products. Moreover, in one embodiment, the system may be used to evaluate an effectiveness of product promotions and to introduce new products at retail. Accordingly, the present invention is useful in increasing the sales of products with the highest profit margin.

Although in the exemplary embodiment SSES 10 is described and illustrated as providing a simulated grocery shopping environment for collecting information relating to the sale of a plurality of grocery products, SSES 10 may be used to provide any suitable simulated shopping environment for collecting information relating to any suitable type of product(s).

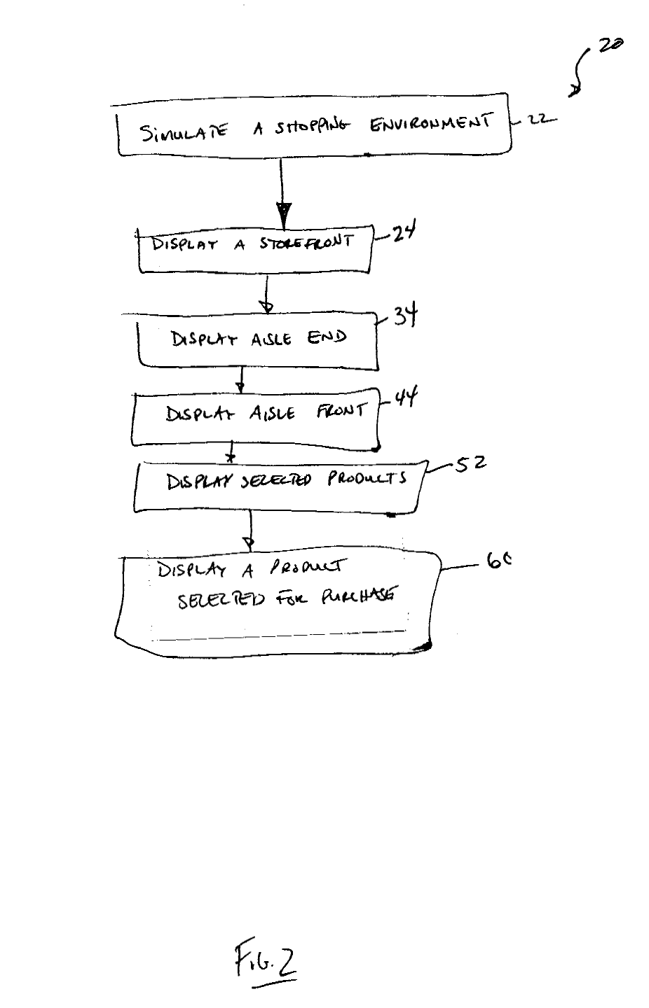

FIG. 2 is a flowchart illustrating an exemplary embodiment of a method 20 for collecting information relating the sale of one or more products, for example using SSES 10 (shown in FIG. 1). Method 20 includes simulating 22 a shopping environment. In the exemplary embodiment, the simulated shopping environment includes a plurality of categories, with each category including at least one product grouped together in one or more aisles. Each aisle includes a plurality of different types of products and a plurality of each different type of product. However, the simulated shopping environment may include any suitable image(s) and/or information for collecting any suitable information relating to the sale of one or more products. For example, in some embodiments the simulated shopping environment may include, in addition or alternative to the exemplary embodiment, a simulated catalog shopping environment wherein a plurality of products are grouped together in one or more pages. Another example of some embodiments of the simulated shopping environment, in addition or alternative to the exemplary embodiment, is a simulated online shopping environment wherein a plurality of produces are grouped together on one or more webpages and/or websites. In some embodiments, method 20 may include providing pre-shopping exposure to a user before simulating 22 the shopping environment. Examples of pre-shopping exposure include, but are not limited to, informational websites, demonstrations, advertisements, videos, coupons, and/or promotions.

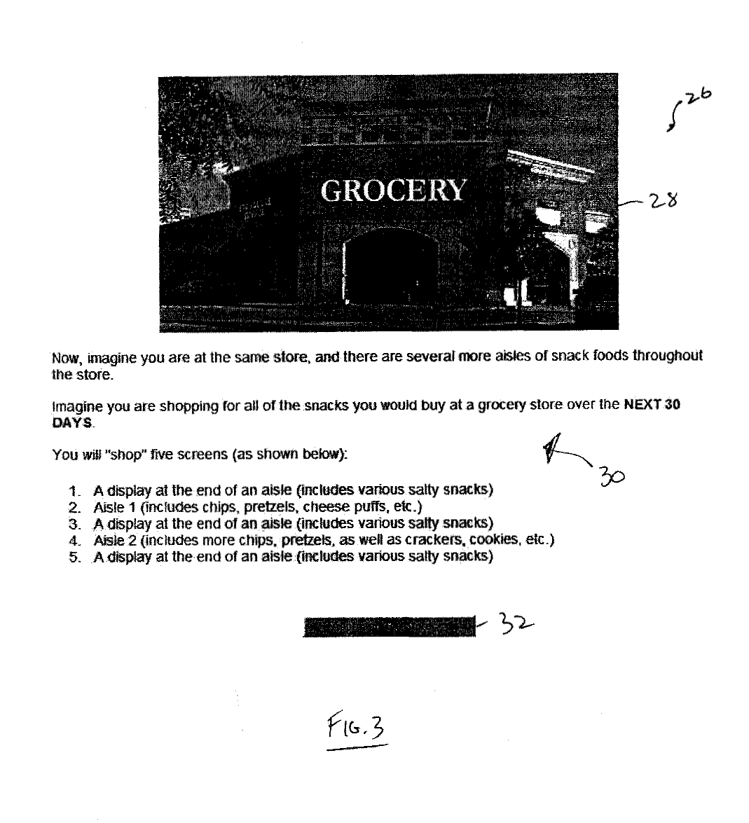

In the exemplary embodiment, simulating 22 the shopping environment includes displaying 24 a storefront. FIG. 3 is an exemplary embodiment of a user interface 26 that displays a storefront. In the exemplary embodiment, storefront user interface 26 includes a photograph 28 of a 2D and/or 3D model or detailed image of a 2D and/or 3D object, exemplary grocery storefront, information 30 describing the simulated shopping environment, and a user input link 32 that gives a user access to the various aisles of products. In other embodiments, storefront user interface 26 does not include photograph 28, information 30, and/or link 32. Moreover, in some embodiments, storefront user interface 26 includes other information, other links, and/or other types of storefront images, such as, but not limited to, drawings, paintings, and/or sketches. In some embodiments, for example wherein the simulated shopping environment includes a simulated online shopping environment and/or a simulated catalog shopping environment, simulating 22 the shopping environment may include, in addition or alternative to displaying 24 a storefront, displaying a shopping interface, such as, but not limited to, a front page (not shown) of a simulated catalog and/or an introductory webpage.

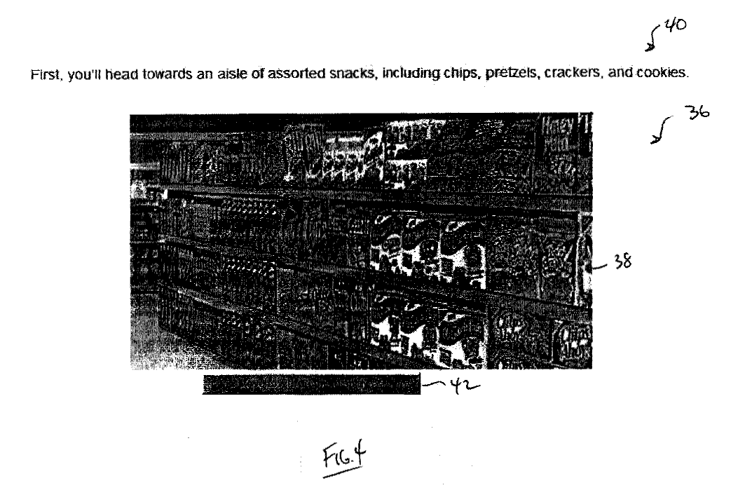

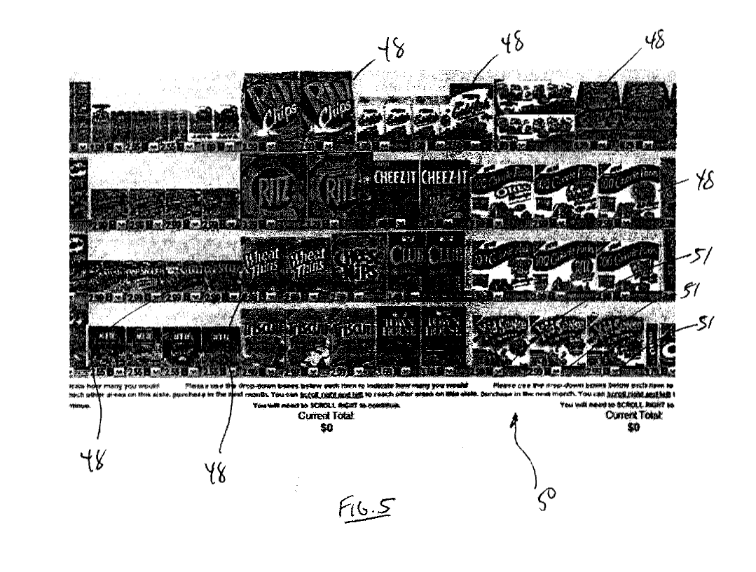

When the user selects link 32 on storefront user interface 26, a user interface displaying an end of an aisle of products is displayed 34. FIG. 4 is an exemplary embodiment of a user interface 36 that displays an end view of an aisle of products. In the exemplary embodiment, user interface 36 includes a photograph 38 of an end of an aisle of products, instructional information 40, and a user input link 42 that gives a user access to the aisle displayed in user interface 36. In other embodiments, user interface 36 does not include photograph 38, information 40, and/or link 42. Moreover, in some embodiments, user interface 36 includes other information, other links, and/or other types of images of an aisle end. When the user selects link 42 on user interface 36, a user interface displaying a front view of the aisle of products is displayed 44. FIG. 5 is an exemplary embodiment of a user interface 46 that displays a front view of the aisle of products. In the exemplary embodiment, user interface 46 includes photographs of 2D and/or 3D objects 48 of each of the products within the aisle and instructional information 50. In the exemplary embodiment, a user can click on each of the objects (photographs 48) to access the selected product(s). Moreover, in the exemplary embodiment, user interface 46 includes separate quantity selectors 51 for selecting a quantity of each product to purchase. In some embodiments, a user can scroll left, right, up, and/or down to view some of the products within the aisle, which may be, for example, indicated within instructional information 50. In other embodiments, user interface 46 does not include photographs 48, selectors 51, and/or information 50. Moreover, in some embodiments, user interface 46 includes other information, other links, and/or other types of images of the products.

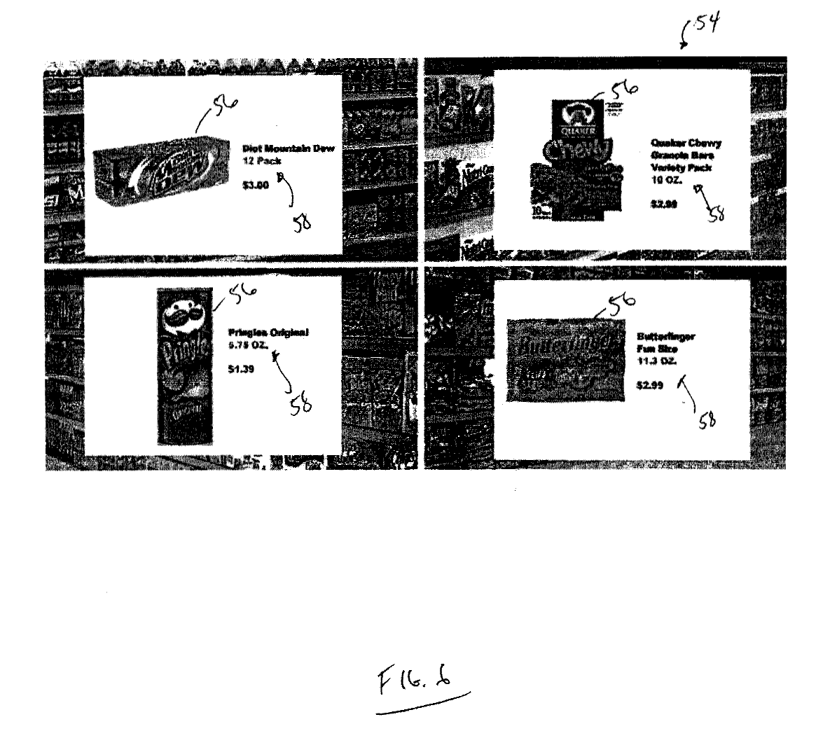

When the user selects a photograph 48 of one or more products, a user interface displaying the selected product(s) is displayed 52. FIG. 6 is an exemplary embodiment of a user interface 54 that displays, for example, four products. In the exemplary embodiment, user interface 54 includes photographs 56 of each of the selected products and information 58 relating to each of the selected products. Examples of information relating to a product include, but are not limited to, a price of one or more products, a size of one or more products, a shape of one or more products, a quantity of one or more products, information relating to the nutrition and/or contents of one or more products, information relating to the packaging of one or more products, a description of one or more products, an advertisement for one or more products, a promotion for one or more products, an incentive for one or more products, a recommendation for one or more products, a demonstration of one or more products, and/or informational resources for one or more products. In the exemplary embodiment, a user can click on each of photographs 56 to select one or more products for purchase. However, in some embodiments, user interface 54 includes separate links (not shown) to purchase each of the products. In other embodiments, user interface 54 does not include photographs 56 and/or information 58. Moreover, in some embodiments, user interface 54 includes other information, other links, and/or other types of images of the selected products.

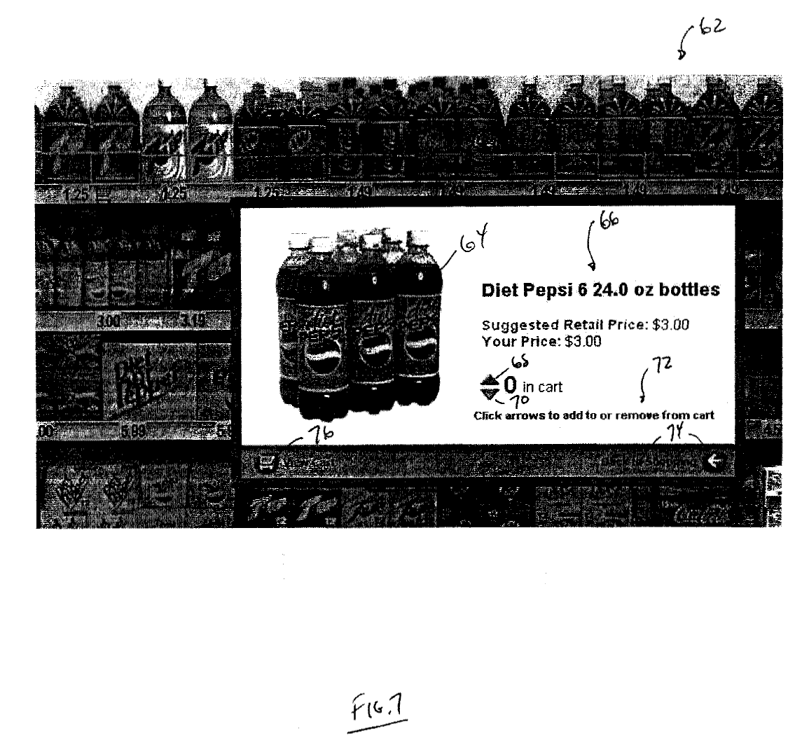

When the user selects a photograph 56 to purchase a product, a user interface displaying the selected product(s) is displayed 60. FIG. 7 is an exemplary embodiment of a user interface 62 that displays a product selected for purchase. In the exemplary embodiment, user interface 62 includes a photograph 64 of the selected product, information 66 relating to the selected product, a link 68 for adding a unit of the product to the user's shopping cart, a link 70 for removing a unit of the product from the user's shopping cart, instructional information 72, a link 74 for accessing the previous user interface 54, and a link 76 for accessing the user's shopping cart. In other embodiments, user interface 62 does not include photograph 64, information 66, link 68, link 70, information 72, link 74, and/or link 76. Moreover, in some embodiments, user interface 60 includes other information, other links, and/or other types of images of the product selected for purchase.

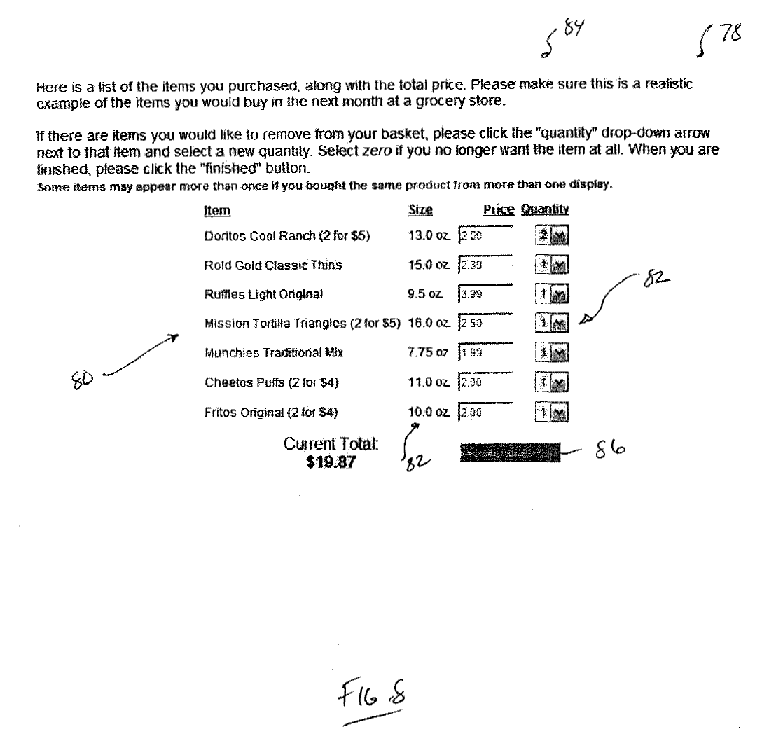

FIG. 8 is an exemplary embodiment of a user interface 78 that displays a user's shopping cart. In the exemplary embodiment, user interface 78 includes a list 80 of products selected for purchase by the user includes, information 82 relating to each of the products selected for purchase, instructional information 84, and a link 86 closing user interface 78. In other embodiments, user interface 78 does not include list 80, information 82, information 84, and/or link 86. Moreover, in some embodiments, user interface 78 includes other information and/or other links.

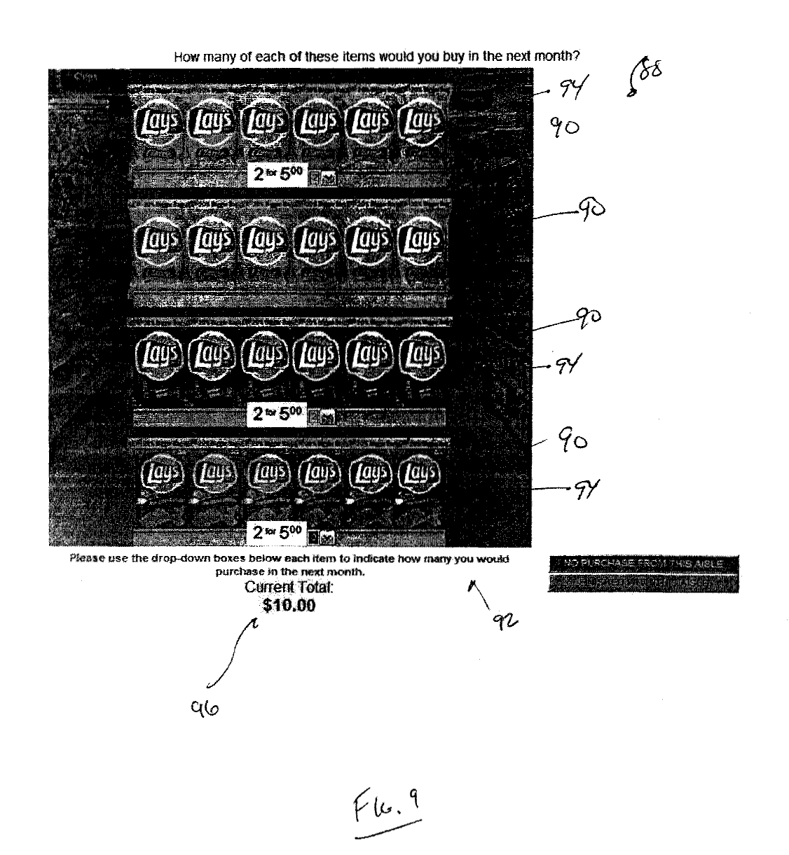

Method 20 may include displaying more than one aisle to the user. FIG. 9 is an exemplary embodiment of a user interface 88 that displays a front view of another aisle of products. In the exemplary embodiment, user interface 88 includes photographs 90 of each of the products within the aisle, instructional information 92, and “current total” information 96 for the selected products. In the exemplary embodiment, user interface 88 includes separate links 94 for selecting a quantity of each product to purchase. However, in some embodiments, a user can click on each of photographs 90 to purchase the selected product(s). In some embodiments, a user can scroll left, right, up, and/or down to view some of the products within the aisle, which may be, for example, indicated within instructional information 92. In other embodiments, user interface 88 does not include photographs 90, information 92, links 94, and/or information 96. Moreover, in some embodiments, user interface 88 includes other information, other links, and/or other types of images of the products. In some embodiments, a user may select each aisle to view, for example in any order the user chooses. In other embodiments, method 20 presents each aisle to the user in a predetermined order.

In some embodiments, a user can move back and forward through method 20 and/or the various user interfaces described and/or illustrated herein using back and forward links (not shown).

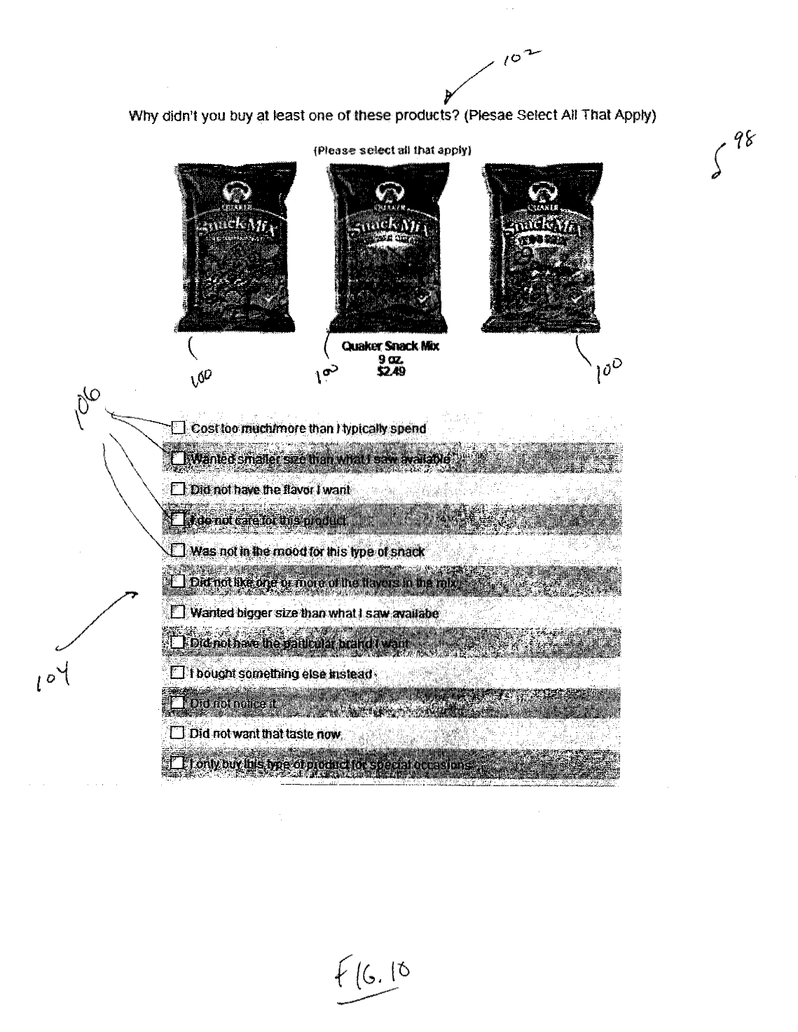

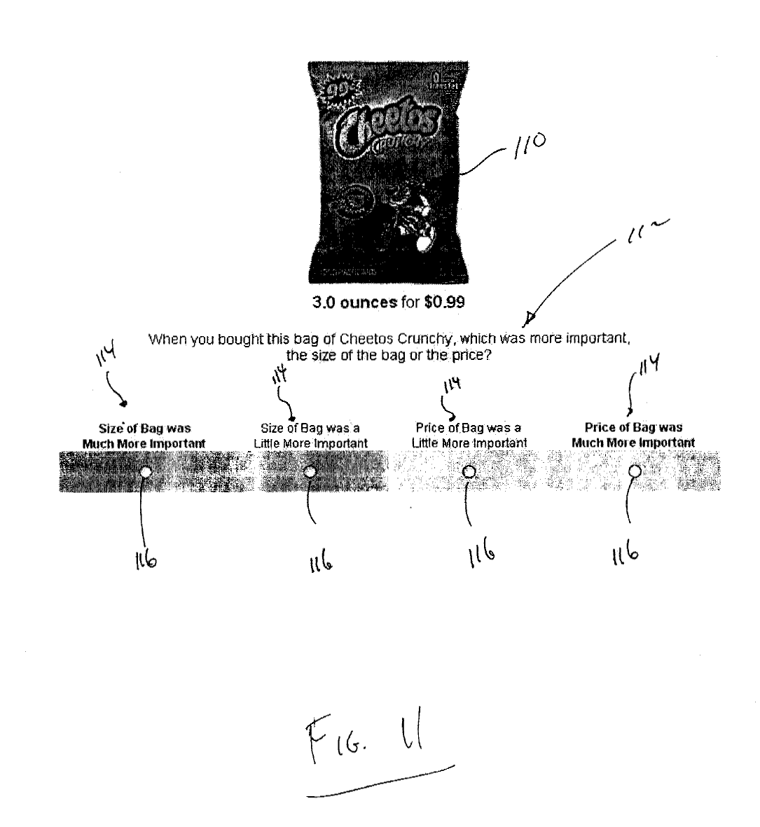

System 10 and method 20 may be used to collect information relating to the shopping habits of potential customers. For example, FIG. 10 is an exemplary embodiment of a user interface 98 that displays an exemplary questionnaire for the user. In the exemplary embodiment, user interface 98 includes photographs 100 of a product, one or more questions 102 relating to the displayed product, potential answers 104 to question(s) 100, and inputs 106 for selection of one or more answers by the user. In other embodiments, user interface 98 does not include photographs 100, question(s) 102, answers 104, and/or inputs 106. Moreover, in some embodiments, user interface 98 includes other questions, other answers, other inputs, and/or other types of images of the product(s). User interface 98 is an example of a questionnaire requesting information from the user relating to why the user did not buy one or more products. FIG. 11 is an exemplary embodiment of a user interface 108 that displays an exemplary questionnaire for the user requesting information from the user relating to one or more products selected for purchase by the user. In the exemplary embodiment, user interface 108 includes a photograph 110 of a product that has been selected for purchase by the user, one or more questions 112 relating to the displayed product, potential answers 114 to question(s) 112, and inputs 116 for selection of one or more answers by the user. In other embodiments, user interface 108 does not include photograph(s) 110, question(s) 112, answers 114, and/or inputs 116. Moreover, in some embodiments, user interface 108 includes other questions, other answers, other inputs, and/or other types of images of the product(s). System 10 and method 20 may also be used to evaluating the effect of product changes within the simulated shopping environment on the purchasing behavior of potential customers.

Accordingly, the above-described systems and methods facilitate optimizing sales of products to customers. In one embodiment, the systems and methods optimize sales by determining an optimal product placement in a store, eliminating a redundancy of products in the store, optimizing sales of a category of product types, and increasing an effectiveness of signage throughout the store. In another embodiment, the systems and methods are used to identify an optimal purchase price for products and maximize a product's packaging appeal to facilitate detracting customers from competitor products. Moreover, in another embodiment, the systems and methods are used to evaluate an effectiveness of product promotions and to introduce new products at retail. Accordingly, the above-described systems and methods are useful in increasing the sales of products with the highest profit margin.

For example, the above-described systems and methods may be used to determine an optimal sales structure for an entire category of products in a retail store, such as, for example, snack foods. The above-described systems and methods can be used to test alternative shelf placements for snack foods, survey customers about optimizing snack food placement in the store, and report results of the surveys and virtual sales to a corporate client using the system, such that the corporate client can implement the results of the virtual shopping experience in an actual retail environment.

In some embodiments, a simulated shopping environment system includes at least one client system, a database, and a server electrically coupled to the database and the client system. The server is configured to simulate a shopping environment using the client system, display on the client system a plurality of products within the simulated shopping environment, and receive a selection of at least one of the plurality of products from a user using the client system. In some embodiments, the server is configured to group the plurality of products into one or more aisles within the simulated shopping environment. In some embodiments, the server is configured to receive a selection from the user using the client system of an aisle to view within the simulated shopping environment. In some embodiments, the server is configured to receiving a selection from the user of a product to purchase. In some embodiments, the server is configured to display a shopping cart within the simulated shopping environment, wherein the shopping cart includes at least one product selected for purchase by the user. In some embodiments, the server is configured to simulate a grocery shopping environment. In some embodiments, the server is configured to evaluate the effect of at least one change to at least one of the plurality of products based on at least one user response. In some embodiments, the server is configured to collect information relating to the shopping habits of potential customers. Such information may include where in the store they shopped, duration of their shopping, and whether products were selected, returned to the shelf or purchased. In addition, the direction in which they shopped the environment can also be tracked.

In some embodiments, a method for collecting information relating to the sale of a plurality of products includes simulating a shopping environment, displaying the plurality of products within the simulated shopping environment, and receiving a selection of at least one of the plurality of products from a user. In some embodiments, displaying the plurality of products within the simulated shopping environment includes grouping the plurality of products into one or more aisles. In some embodiments, the method includes receiving a selection from the user of an aisle to view within the simulated shopping environment. In some embodiments, the method includes receiving a selection from the user of a product to purchase. In some embodiments, the method includes displaying a shopping cart within the simulated shopping environment, wherein the shopping cart includes at least one product selected for purchase by the user. In some embodiments, simulating a shopping environment includes simulating a grocery shopping environment. In some embodiments, the method includes evaluating the effect of at least one change to at least one of the plurality of products based on at least one user response. In some embodiments, the method includes collecting information relating to the shopping habits of potential customers.

Exemplary embodiments of systems and methods are described and/or illustrated herein in detail. The systems and methods are not limited to the specific embodiments described herein, but rather, components of each system, as well as steps of each method, may be utilized independently and separately from other components and steps described herein. Each component, and each method step, can also be used in combination with other components and/or method steps.

When introducing elements/components/etc. of the systems and methods described and/or illustrated herein, the articles “a”, “an”, “the” and “said” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

What is claimed is:

1. A method for collecting information related to the possible consumer purchase of products, said method comprising:
simulating a shopping environment;
displaying a plurality of products within the simulated shopping environment; and
collecting information based on an opportunity to select at least one of the plurality of products by a user.

2. A method in accordance with claim 1 wherein simulating a shopping environment further comprises simulating at least one of a store, a catalog, and an online shopping website.

3. A method in accordance with claim 2 wherein simulating a store comprises simulating at least one aisle of a store, and displaying a plurality of products within the simulated shopping environment comprises displaying the plurality of products in the at least one aisle.

4. A method in accordance with claim 1 further comprising displaying information related to the plurality of products.

5. A method in accordance with claim 1 further comprising collecting information related to at least one of the user's shopping habits and an effect of product changes on the user's purchasing behavior.

6. A method in accordance with claim 1 further comprising authorizing at least one individual to change information related to the plurality of products.

7. A method in accordance with claim 1 further comprising displaying a questionnaire to facilitate collecting information from the user.

8. A method in accordance with claim 1 further comprising displaying a shopping cart that includes at least one of a list of products selected by the user and information related to the products selected by the user.

9. A method in accordance with claim 1 further comprising optimizing the sale of the plurality of products by at least one of determining an optimal placement of the plurality of products within a store, eliminating a redundancy of the plurality of products within the store, optimizing the sale of products within preselected product categories, and increasing an effectiveness of product signage throughout the store.

10. A method in accordance with claim 1 further comprising at least one of identifying an optimal purchase price for the plurality of products and maximize a packaging appeal of the plurality of products to facilitate detracting customers from competitor products.

11. A method in accordance with claim 1 further comprising evaluating an effectiveness of promotions for the plurality of products.

12. A simulated shopping environment comprising at least one client system, a database, and a server electronically coupled to said at least one client system and said database, wherein said server is configured to:
simulate a shopping environment on said client system;
display a plurality of products within the simulated shopping environment; and
collect information based on a selection of at least one of the plurality of products by a user.

13. A simulated shopping environment in accordance with claim 9, wherein said server is further configured to simulate at least one of a store, a catalog, and an online shopping website on the client system.

14. A simulated shopping environment in accordance with claim 10, wherein said server is further configured to:
simulate at least one aisle of the store; and
display the plurality of products in the at least one aisle.

15. A simulated shopping environment in accordance with claim 9, wherein said server is further configured to display information related to the plurality of products.

16. A simulated shopping environment in accordance with claim 9, wherein said server is further configured to collect information related to at least one of the user's shopping habits and an effect of product changes on the user's purchasing behavior.

17. A simulated shopping environment in accordance with claim 9, wherein said server is further configured to display a questionnaire to facilitate collecting information from the user.

18. A simulated shopping environment in accordance with claim 9, wherein said server is further configured to authorize at least one individual to change information related to the plurality of products.

19. A computer program embodied on a computer-readable medium for collecting information related to the sale of products, said computer program comprising a code segment configured to:
simulate a shopping environment;
display a plurality of products within the simulated shopping environment; and
collect information based on a selection of at least one of the plurality of products by a user.

20. A computer program in accordance with claim 16 further comprising a code segment configured to simulate at least one of a store, a catalog, and an online shopping website.

21. A computer program in accordance with claim 16 further comprising a code segment configured to display information related to the plurality of products.

22. A computer program in accordance with claim 16 further comprising a code segment configured to collect information related to at least one of the user's shopping habits and an effect of product changes on the user's purchasing behavior.

23. A computer program in accordance with claim 16 further comprising a code segment configured to display a questionnaire to facilitate collecting information from the user.
